(19) United States
(12) Patent Application Publication
(10) Pub. No.: US 2022/0071112 A1
(43) Pub. Date: Mar. 10, 2022

(54) METHOD FOR SUBSTRATE-FREE COMMON ROOTING OF A PLURALITY OF UNROOTED CUTTINGS

(71) Applicant: SELECTA KLEMM GMBH & CO. KG, Stuttgart (DE)

(72) Inventors: Stefan REINER, Affalterbach (DE); Dirk SCHIMMELPFENG, Remseck (DE); Per KLEMM, Stuttgart (DE)

(21) Appl. No.: 17/045,846

(22) PCT Filed: May 29, 2019
(86) PCT No.: PCT/EP2019/064083

§ 371 Date: Oct. 7, 2020

(51) Int. Cl. A01G 31/02; A01G 2/10

(52) U.S. Cl. CPC A01G 31/02; A01G 2/10

(57) ABSTRACT

The invention relates to a method for the substrate-free rooting of a plurality of unrooted cuttings, comprising the steps:
providing a carrier strip having a plurality of cavities which are open at the top for receiving in each case an unrooted cutting in each cavity, wherein each cavity is provided with openings at least in a region associated with a cutting base,
inserting an unrooted cutting into each cavity,
applying a water-persistant, water- and air-permeable climate membrane to the carrier strip provided with the cuttings in such a manner that at least the region of each cavity of the carrier strip that is associated with the cutting base is surrounded by the climate membrane,
arranging the carrier strip provided with the climate membrane in a rooting station and leaving the cuttings to root for a predetermined period of time, with regular misting, and
at the end of the predetermined rooting period, dispatching the carrier strip with the rooted cuttings for further processing, or separating the carrier strip into sections each having at least one rooted cutting and dispatching the sections for further processing.

The rooting of cuttings nowadays takes place millionfold within the scope of the vegetative propagation of ornamental and agricultural crops. For this purpose, the cuttings are conventionally planted in a moist substrate in order to develop roots therein. As substrate, for example, soil, perlite, vermiculite, coir, mineral wool, or expanded clay pellets can be used. The cuttings are usually first cultivated in small containers and then, after the first roots have developed, transplanted into larger containers, in which they are later also dispatched to customers. The plants are then further cultivated by the customers in yet other containers until they are ready for sale.

The described process of cultivating cuttings is relatively lengthy and also associated with losses, since not all cuttings develop as desired. Methods are therefore sought which on the one hand reduce the outlay in the cultivation of cuttings and on the other hand yield better results, such as, for example, larger and more stable plants and fewer losses. The object of the present invention is to provide such a method.

In order to solve the problem mentioned above, the present invention proposes a method for the substrate-free rooting of a plurality of unrooted cuttings, which comprises the following steps:
providing a carrier strip having a plurality of cavities which are open at the top for receiving in each case an unrooted cutting in each cavity, wherein each cavity is provided with openings at least in a region associated with a cutting base,
inserting an unrooted cutting into each cavity,
applying a water-persistant,water- and air-permeable climate membrane to the carrier strip provided with the cuttings in such a manner that at least the region of each cavity of the carrier strip that is associated with the cutting base is enclosed by the climate membrane,
arranging the carrier strip provided with the climate membrane in a rooting station and leaving the cuttings to root for a predetermined period of time, with regular misting, and
at the end of the predetermined rooting period, dispatching the carrier strip with the rooted cuttings for further processing, or separating the carrier strip into sections each having at least one rooted cutting and dispatching the sections for further processing.

The carrier strip provided according to the invention is preferably in such a form that each cutting is held clamped in the associated cavity of the carrier strip. In order that the further development of the cuttings proceeds as uniformly as possible, the cuttings used should where possible all be of the same size and maturity. A suitable carrier strip for use in the method according to the invention is, for example, a carrier strip supplied by Visser Horti Systems under the name AutoStix™. These carrier strips are currently supplied with 34 or 51 cavities arranged side by side in a linear manner. Carrier strips of this kind are intended to be filled with cuttings and then introduced into a substrate so that the cuttings callus and/or develop roots in the substrate.

According to the invention, however, this callusing and/or rooting of the cuttings takes place without a substrate. In order to achieve this aim, a water-persistant, water- and air-permeable climate membrane is first applied to the carrier strip filled with cuttings in such a manner that at least the region of each cavity of the carrier strip that is associated with the cutting base is enclosed by the climate membrane. Water-persistant means in this respect that the climate membrane does not dissolve in water or does not degrade under the exposure of water. The climate membrane can be paper-like (with or without perforations), film-like (in particular perforated), fabric-like or nonwoven-like. As material for the climate membrane, in addition to the materials used for producing paper, also plastic materials and natural fibres can be considered. The climate membrane can also consist of a composite material.

Preferably, the climate membrane has a certain liquid-absorbing or liquid-storing capacity, in order thus to achieve a buffering effect and to be able to maintain a basic moisture level around the cutting bases for a longer period. In other words, the climate membrane preferably has a certain absorbency, which can be achieved, for example, by means of cellulose as a constituent of the climate membrane. However, other substances also come into consideration as liquid stores, for example so-called superabsorbers as well as plastic fibres or natural fibres. Forms of the climate membrane that are preferred in the method according to the invention have a liquid-absorbing capacity of at least 100 g of liquid, preferably of at least 200 g of liquid and particularly preferably of at least 300 g of liquid, per 100 g of dry weight of the climate membrane. The climate membrane is preferably designed in a manner that it can absorb the corresponding amount of liquid quickly, that is to say within a period of from a few seconds to not more than a few minutes, so that the liquid supplied by way of misting can be stored effectively.

The climate membrane can be applied to the carrier strip in different ways. According to a preferred embodiment of the method according to the invention, the climate membrane is folded into a V-shape before it is applied to the carrier strip and is then pushed onto the carrier strip from beneath. Front and rear ends of the climate membrane protruding above the carrier strip are then stapled together in such a manner that the climate membrane fits closely to the carrier strip. Alternatively, and/or additionally, the carrier strip can have multiple hooks laterally on its outer side, into which hooks the climate membrane can be hooked. The hooks can be in the form of barbed hooks, in order to make it difficult for the climate membrane to become unintentionally detached from the carrier strip. The shape of the climate membrane is adapted to the carrier strip and accordingly is preferably likewise in strip form or at least elongate. The exact form of the climate membrane used and the manner in which it is fastened are not important; it must simply be ensured that, in the state in which it is fastened to the carrier strip, the climate membrane closely surrounds at least the region of the carrier strip that is associated with the cutting bases. In a preferred embodiment of the method according to the invention, the climate membrane, in the state in which it is applied to the carrier strip, extends laterally into the region of the upper side of each cavity of the carrier strip.

The carrier strips provided with the climate membrane in such a manner are then introduced into a rooting station, in which the cuttings remain for a predetermined period of time, with regular misting, in order to root. This predetermined period of time can be, for example, from 2 to 3 weeks. In the rooting station, the climate membrane serves to create a constant microclimate in the region of the cutting bases, in which rooting takes place. Owing to its water- and air-permeability, the climate membrane maintains the microclimate at the cutting bases in an optimal range for rooting, in that the climate membrane on the one hand prevents the cutting bases from standing in liquid, which would facilitate rotting, and on the other hand prevents the cutting bases from drying out, which likewise would not be conducive to rooting of the cuttings. The degree of regular misting is adapted to the cuttings in the carrier strips, that is to say cuttings of a plant species or variety that requires more water are misted more frequently than cuttings of a plant species or variety that requires only a little moisture for rooting.

According to the invention, it is no longer necessary to transfer the cuttings in the carrier strips to larger containers before the rooted cuttings are despatched to a customer, for example. Instead, at the end of the predetermined rooting period, which differs according to the plant species or variety, the cuttings in the carrier strips are rooted well enough to be dispatched, for example, to customers in the carrier strips and transferred by the customer directly to the containers in which they will be further cultivated.

According to a particularly preferred embodiment of the method according to the invention, before the climate membrane is applied, each of the carrier strips filled with unrooted cuttings is first immersed for a predetermined period of time in a hormone solution in such a manner that the cutting base of each cutting is in the hormone solution. The predetermined period of time for which the carrier strips provided with cuttings are immersed in the hormone solution can be, for example, between three and eight hours and is preferably approximately six hours. During the predetermined period of time, the cuttings in the carrier strips are misted regularly in order to prevent them from drying out.

At the end of the predetermined period of time in the hormone solution, the climate membrane is applied to each carrier strip, as already described hereinbefore. The climate membrane then absorbs some of the hormone solution at the cutting bases and thereby prevents the hormone solution from being washed out too quickly during subsequent misting in the rooting station. The application time of the hormone solution in the region of the cutting bases is thus extended significantly by means of the climate membrane. The same is true for each further treatment carried out during rooting, such as, for example, fertilisation as well as biological and fungicidal treatments. According to an alternative embodiment of the method according to the invention, the climate membrane can also be applied to the carrier strip before the carrier strip provided with the cuttings is immersed in a hormone solution for the predetermined period of time. In any case, the climate membrane ensures, during the subsequent rooting phase, that the moisture and the microclimate around the cutting bases are optimal for uniform callusing and/or root development.

Preferably, at the end of the rooting process in the rooting station, the rooted cuttings are washed with a solution containing mycorrhiza. This promotes root branching and increases the robustness of the rooted cuttings.

Depending on the further use, intended by the customer, of the carrier strips containing the now rooted cuttings, the climate membrane can be removed prior to the despatch step and roots protruding from the bottom of the carrier strip can then be cut off. This is recommended in particular when the carrier strips containing the rooted cuttings are to be further processed by machine, since roots protruding from the bottom of the carrier strip can lead, for example, to blocking of a mechanical separating device. When cutting off the roots protruding from the bottom of the carrier strip, it should be ensured that damage to the roots is minimised, that is to say only as much as necessary and as little as possible is cut off. Cutting back the roots in the described manner prior to dispatch has the advantage that the wounds produced at the roots by the cutting back close during transport to the customer and the roots re-branch again and develop root hairs. It is advantageous to cut the roots close to the root base since re-branching and root hair formation then take place directly at the root base. For the customer, cutting back the roots prior to dispatch has significant advantages in relation to more even and less problematical growth of the rooted cuttings in less time. Overall, the stock is more homogeneous, there are fewer losses and the cultivation time (that is to say the cultivation time until the plant is ready for sale) is shorter. If the roots are not cut back as described prior to despatch, most root hairs are at or close to the root tips. During the transport and subsequent further processing of such cuttings with roots that have not been cut back, there is the risk that the root tips will break off, with the result that the root hairs at the root tips are also lost. This risk is reduced significantly by cutting off the roots as described prior to dispatch and moreover, as described, new root branches and root hairs can develop close to the root base during the transportation period, which leads to the mentioned advantages.

Cutting back the roots as described prior to despatch of the rooted cuttings in the carrier strips has an advantageous effect even without the prior use of a climate membrane. According to a further aspect, the present invention is therefore also directed to a method for the substrate-free joint rooting of a plurality of unrooted cuttings by means of carrier strips, in which the roots protruding from the bottom of the carrier strip are cut off the rooted cuttings in the carrier strips, shortly before or after their stay in the rooting station and prior to dispatch. Specifically, such a method can thus comprise the following steps:
providing a carrier strip having a plurality of cavities which are open at the top for receiving in each case a rootless cutting in each cavity, wherein each cavity is provided with openings at least in the region associated with a cutting base,
inserting an unrooted cutting into each cavity,
arranging the carrier strip in a rooting station and leaving the cuttings to root for a predetermined period of time, with regular misting,
shortly before or at the end of the predetermined rooting period, cutting off the roots protruding from the bottom of the carrier strip, and
dispatching the carrier strip with the rooted cuttings for further processing, or separating the carrier strip into sections each having at least one rooted cutting and despatching the sections for further processing.

If, as described hereinbefore, the climate membrane is removed and roots protruding from the bottom of the carrier strip are cut off before the despatch step, then, according to a preferred embodiment of the method according to the invention, a new climate membrane is applied to each carrier strip in the same manner as before. Preferably, this new climate membrane is impregnated with a fertiliser solution. The new climate membrane protects the roots during transport to the customer and, through the fertiliser solution, promotes further root growth and further root branching, which results for the customer in a product that can be transplanted even more reliably. In a particularly preferred embodiment of the method according to the invention, the roots of the cuttings are treated with a plant strengthener before the new climate membrane is applied, whereby the described advantageous effects are enhanced further.

Within the scope of experimental tests, positive experiences have been made with climate membranes having an air permeability in the range of from 1100 to 1200 l/m²s. It has further been found to be advantageous that the climate membrane has a tensile strength of from 13.0 N to 16.0 N/15 mm in the machine direction (based on the process of paper production) and from 7.0 N to 9.5 N/15 mm transversely to the machine direction (again based on the paper production process). A climate membrane with which particularly good results were achieved was a product from the Danish company Ellepot designated “20-70-1400-VP Brown FSC®” and with the sub-designation “FSC Mix NC-COC-016680”.

In general, preference is given to climate membranes of a dark colour, because light is thereby prevented from reaching the cuttings, which slows root growth.

In summary, the method according to the invention provides the possibility of reducing the costs of the cultivation of cuttings in that, with fewer working steps, cuttings are obtained that can be transferred by the customer (in particular by producers of finished products) directly into the containers in which the plants are then sold. The cultivation time is thereby shortened by, on average, three weeks, whereby the space needed by the producer of finished products for the propagation process is also reduced.

An exemplary embodiment of the method according to the invention will be described in greater detail hereinbelow. Cuttings of the variety Gaura Lindheimerii Belleza® Dark Pink are to be rooted. For this purpose, unrooted cuttings were first inserted into carrier strips of the Visser AutoStix™ type, whereby it was ensured that the unrooted cuttings were uniform in terms of size and maturity.

The carrier strips filled with unrooted cuttings in such a manner were then immersed for six hours in a 30 ppm IBA hormone solution in such a manner that the cutting bases were submerged. In order to prevent the cuttings from drying out, regular misting was carried out during the treatment with the hormone solution.

Immediately after completion of the hormone treatment, a climate membrane designated 20-70-1400-VP Brown FSC® from the Danish company Ellepot was placed around the region of each carrier strip in which the cutting bases are located. The climate membrane used had a liquid-absorbing capacity of approximately 340 g per 100 g of dry climate membrane. For that purpose, the climate membrane in strip form was folded into a V-shape and then pushed onto the carrier strip from beneath and finally fastened to the carrier strip by stapling the two longitudinal ends of the strip-shaped climate membrane together. Hormone solution at the cutting bases is absorbed by the climate membrane and thereby intermediately stored close to the cutting bases. The climate membrane used ensures that the microclimate around the cutting bases is maintained in an optimal range for uniform callusing and root development.

The carrier strips provided with the climate membrane were then kept in rooting containers in a rooting station for a period of three weeks in order to allow the rooting process to take place. The rooting station is a region with a regulated temperature and controlled supply of light and humidity. Humidity was supplied by means of misting, whereby a fertiliser (fertiliser with an EC of 1.8) was added to the mist. Misting took place initially at intervals of ten seconds every ten minutes. During the first two weeks, the intervals were increased stepwise until the cuttings were sufficiently hardy and misting could be stopped. One week before the end of the rooting period, the cuttings were pinched out manually by means of scissors. At the end of the rooting period, that is to say a few days before dispatch, the cuttings were subjected to washing with mycorrhiza, in order to promote root branching and durability of the cuttings. On the day before they were dispatched, the cuttings were further preventively treated with a broad-spectrum fungicide.

At the end of the rooting period, the now rooted cuttings in the carrier strips were prepared for dispatch. For this purpose, the climate membrane was first removed and the roots protruding from the bottom of the carrier strip were cut off. Such cutting back is necessary in order that the carrier strips filled with the cuttings can be further processed by machine by the customer (frequently a producer of finished products). However, cutting back the roots also has the result that new and rapid root branching and root hair formation take place at the cutting bases during transport. In order to further support this new root branching and root hair formation, a new climate membrane was applied to each carrier strip in the same manner as described hereinbefore after the roots had been cut back. This new climate membrane was immersed beforehand in a fertiliser solution and a plant strengthener solution. The microclimate which is thus established around the cutting bases during the transport period is extremely conducive to renewed root branching and root hair development in the region of the root bases.

The carrier strips so provided with a new climate membrane can then be surrounded with damp paper and placed in designated transport containers. At the customer, the climate membrane is removed before the carrier strips provided with the rooted cuttings are further processed by machine.

1. A method for the substrate-free rooting of a plurality of unrooted cuttings, the method comprising the steps:
providing a carrier strip having a plurality of cavities which are open at the top for receiving in each case a rootless cutting in each cavity, wherein each cavity is provided with openings at least in a region associated with a cutting base,
inserting an unrooted cutting into each cavity,
applying a water-persistant, water- and air-permeable climate membrane to the carrier strip provided with the cuttings in such a manner that at least the region of each cavity of the carrier strip that is associated with the cutting base is enclosed by the climate membrane,
arranging the carrier strip provided with the climate membrane in a rooting station and leaving the cuttings to root for a predetermined period of time, with regular misting, and
at the end of the predetermined rooting period, dispatching the carrier strip with the rooted cuttings for further processing, or separating the carrier strip into sections each having at least one rooted cutting and despatching the sections for further processing.

2. The method according to claim 1, wherein, after the step of inserting an unrooted cutting into each cavity, the carrier strip provided with the cuttings is immersed for a predetermined period of time in a hormone solution in such a manner that the cutting base of each cutting is in the hormone solution, and in that, during the predetermined period of time, regular misting takes place.

3. The method according to claim 2, wherein the predetermined period of time is between 3 and 8 hours and is preferably approximately 6 hours.

4. The method according to claim 1, wherein regular misting in the rooting station contains a fertiliser.

5. The method according to claim 1, wherein, at the end of the rooting process in the rooting station, the rooted cuttings are washed with a solution containing mycorrhiza.

6. The method according to claim 1, wherein, before the dispatch step, the climate membrane is removed and roots protruding from the bottom of the carrier strip are cut off.

7. The method according to claim 6, wherein, after the roots protruding from the bottom of the carrier strip have been cut off, a new climate membrane is applied in the same manner as before.

8. The method according to claim 7, wherein, before the new climate membrane is applied, the roots of the cuttings are treated with a plant strengthener.

9. The method according to claim 7, wherein the new climate membrane is impregnated with a fertiliser solution.

10. The method according to claim 1, wherein the climate membrane has a tensile strength of from 13.0 N to 16.0 N/15 mm in the machine direction and from 7.0 N to 9.5 N/15 mm transversely to the machine direction.

11. The method according to claim 1, wherein the climate membrane has an air permeability in the range of from 1100 to 1200 l/m²s.

12. The method according to claim 1, wherein the climate membrane has a liquid-absorbing capacity of at least 100 g of liquid, preferably of at least 200 g of liquid and particularly preferably of at least 300 g of liquid, per 100 g of dry weight of the climate membrane.

13. The method according to claim 1, wherein the climate membrane is in strip form.

14. The method according to claim 13, wherein the climate membrane is folded into a V-shape before being applied to the carrier strip and is then pushed onto the carrier strip from beneath.

15. The method according to claim 1, wherein there is used as the carrier strip an AutoStix™ carrier strip.
